(19) United States
(12) Patent Application Publication
(10) Pub. No.: US 2010/0282701 A1
(43) Pub. Date: Nov. 11, 2010

(54) ARM MADE OF COMPOSITE MATERIAL AND RELATIVE PRODUCTION METHOD

(75) Inventors: Mauro Marco CORTELLINI, Rozanno (IT); Paolo Dario Maini, Monza (IT); Andrea Bernasconi, Milano (IT); Stefano Beretta, Voghera (IT)

Correspondence Address: Novak Druce + Quigg, LLP, 300 New Jersey Ave, NW, Fifth Floor, Washington, DC, 20001, US

(73) Assignee: CIFA SPA, Senago (IT)

(21) Appl. No.: 12/726,530

(22) Filed: Mar. 18, 2010

(30) Foreign Application Priority Data
May 6, 2009 (IT) UD2009A000090

(51) Int. Cl. B66C 23/42; B29C 65/48

(52) U.S. Cl. 212/300; 156/294

(57) ABSTRACT

An arm made of composite material, and relative production method, consisting of a plurality of articulated segments with a longitudinal main axis (x), pivoted to each other, each of the articulated segments comprising a box-like structure and at least a joint element attached thereto by means of gluing, the box-like structure having an end cooperating with an end of the joint element on the inside of the surface of the joint element. The ends define a substantially conical reciprocally overlapping area and have profiles concordantly inclined by an angle (α) with respect to the longitudinal axis (x).

### FIELD OF THE INVENTION

The present invention concerns an arm made of composite material and the relative production method.

In particular, the present invention is advantageously applied particularly on concrete mixers or the like, and even more particularly in all those cases in which the arms of these vehicles are required to reach large total heights and lengths, and support considerable weights. Advantageously it is preferably applied in the building sector, for the distribution of concrete or other similar material, and it is preferably of the type comprising a plurality of articulated segments pivoted with respect to each other at the ends.

### BACKGROUND OF THE INVENTION

Heavy work vehicles used in the building sector are known, usually consisting of a truck on which an arm is assembled which has a plurality of articulated segments pivoted with respect to each other at the ends. The arm can be oriented, extended and/or telescopically opened for the distribution of concrete or similar material. The arm is able to reach considerable distances from the truck so as to guarantee maximum flexibility of use of the heavy work vehicle. The overall weight of the arm increases with the increase in distance which it can reach, and this depends on the number and the length of the articulated segments which make it up. The need for flexibility therefore conflicts with the limits of bulk and weight of the arm itself.

From the European patent application EP-08164624.2, in the name of the present Applicant, an extendable arm is known for the distribution of concrete, at least partly made of composite material so as to reduce the weight of the arm, given the same extension reached, with respect to a traditional arm made of metal material. The composite material has good characteristics of resistance and rigidness, but also greater lightness.

Based on the idea of using composite material for the construction of the articulated arm, the European patent application EP-08152672.5, also in the name of the present Applicant, shows a possible construction technique for the arm, which aims to reduce production costs, guaranteeing maximum flexibility and versatility of production. According to this technique each main box-like structure of the segments of the arm is formed by depositing a predefined plurality of layers of pre-impregnated composite material in a forming mold. Then this box-like structure made of composite material is subjected to polymerization and, once removed from the mold, terminal joint elements are attached to it in order to attach it to other adjacent segments, in order to form, once assembly is completed, an arm with articulated segments. At the same time as the arms were designed, an experiment was made with a gluing technique to glue the box-like structure to a joint element so as to form a complete segment. More specifically, in FIG. 4 a gluing area 122 between ends 123a and 124a is schematically shown, belonging respectively to a box-like structure 123 and to a joint element 124 of a generic articulated segment 112-116. The ends 124a of the element 124 are coupled parallel and glued on the outside to the respective ends 123a of the structure 123 by means of a layer of glue, or other adhesive material 25 interposed. The angle formed between the longitudinal axis of the box-like structure 123 and the profile of the end 123a of the box-like structure 123 is zero. Experimental tests showed that, during the action of the arm, on the layer of glue 25 a shearing power is exerted coincident with the axial force generated by a flexion moment applied. The axial force is parallel to the longitudinal axis of the articulated segment 112-116 considered. It was shown experimentally that the tension state, and therefore the resistance criterion for the layer of glue 25, is dominated, for the most part, by the action of the shearing force, defined as that force which tends to make the overlapping ends 123a and 124a slide one on top of the other.

One disadvantage of this gluing method is that the layer of glue 25 is in a high state of tension when the articulated segment 112-116 is in use. Indeed the shearing force is high, coinciding with the axial force applied. Consequently, the stresses which affect the layer of glue interposed between the boxed beams and the terminal joint are high, and the fatigue damage is significant, resulting in a limited working life of the articulated segment and therefore of the arm which it comprises.

Purpose of the present invention is to make an element, or segment, of an articulated arm in which the technique of connecting the boxed beam and terminal joint allows to lengthen the duration of the working life of the arm.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, an arm made of composite material according to the present invention consists of a plurality of articulated segments with a main longitudinal axis, pivoted to each other at the ends. The arm, in the transport position, has its constituent segments bent back one on the other so as to take up as little bulk as possible, while, in the work position, the segments are all or partly extended or unfolded in order to reach the desired distance. Each articulated segment according to the invention comprises a box-like structure made of composite material and at least a joint element, attached by means of gluing to the box-like structure so as to allow connection with another adjacent segment of the articulated arm. The box-like structure has one end cooperating with an end of the joint element on the inside of the surface of the joint element, defining an overlapping area.

According to a characteristic feature of the present invention, the overlapping area between the end of the box-like structure and the mating end of the joint element defines a substantially conical coupling. Substantially conical coupling means, here and hereafter, an area of coupling belonging to a conical or truncated cone surface, in which the ends of the box-like structure and the joint element to be reciprocally glued have profiles which are concordantly inclined at the same angle with respect to the main axis of the articulated segment. This type of coupling allows to increase the overlapping area with respect to the case with no inclination, reducing the tangential stresses which affect the layer of glue interposed between the two ends to be connected, given the same load applied.

According to a variant of the present invention, the angle of inclination of the profiles of the ends of the box-like structure and of the joint element is comprised between 1 and 5 degrees inclusive. The choice of this range depends on the fact that an inclination value of less than 1 degree would be insufficient to determine an appreciable increase in the gluing area with respect to the case in which this inclination was zero. On the other hand, a value higher than 5 degrees would imply a considerable increase in the overlapping area, but would have the disadvantage of generating a normal force to the main longitudinal axis not negligible in modulus, tending to separate the parts made of composite material.

According to a further variant of the present invention, the angle of inclination is comprised between 2.5 and 3.5 degrees. This range is particularly advantageous as it determines an optimal compromise between the overlapping area generated, which should be as big as possible, and the normal force modulus acting on the layer of glue, which should be as low as possible.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral view of a heavy work vehicle on which an arm made of composite material according to the present invention is installed, in a folded condition used for transport;

FIG. 2 is a detailed view of a portion of articulated segment which is comprised in an extendable arm according to the invention;

FIG. 3 is a section from III to III of a portion of articulated segment which is comprised in an extendable arm according to the invention;

FIG. 4 is a schematic representation of a detail of an articulated segment of an arm;

FIG. 5 is a schematic representation of a detail of an articulated segment of an arm.

### DETAILED DESCRIPTION OF A PREFERENTIAL FORM OF EMBODIMENT

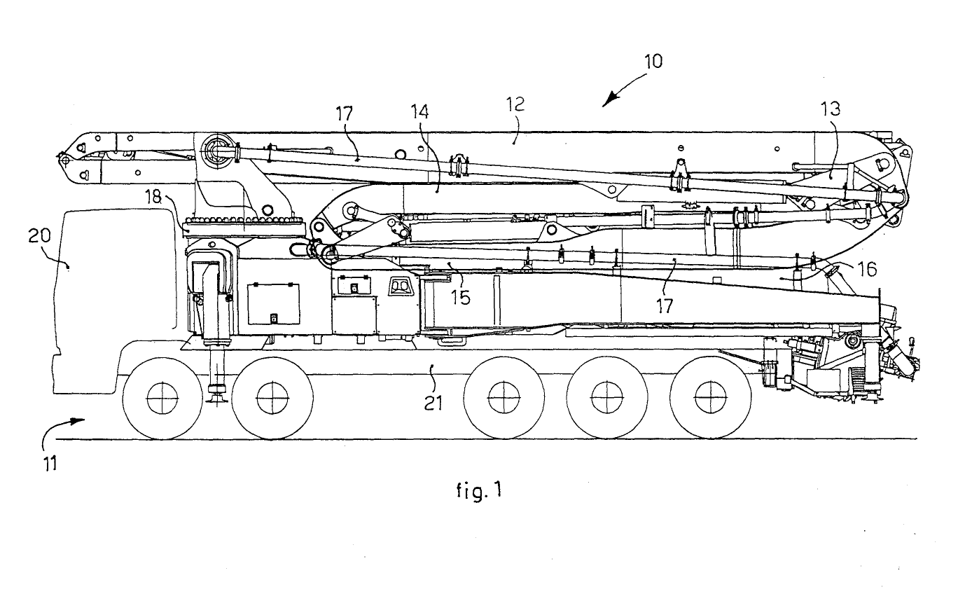

With reference to FIG. 1, an arm made of composite material 10 according to the present invention, able to distribute concrete or similar material for the building trade, is shown in an assembled position on a heavy work vehicle 11, in a folded position for transport. The heavy vehicle 11 comprises a drive cabin 20 and a support bench 21 on which the arm made of composite material 10 is assembled. The arm 10 according to the present invention comprises a plurality of articulated segments, in this case five, respectively, a first 12, a second 13, a third 14, a fourth 15 and a fifth 16, pivoted with respect to each other at their respective ends. There is also a pipe 17, to feed and discharge the cement. With reference to FIG. 1, the first segment 12, in a known manner, is pivoted to a turret 18, and can be rotated with respect to it. The other segments 13-16 are pivoted in sequence with respect to each other at respective ends and can be driven individually, by means of actuators, according to specific needs. Each segment 12-16 is used to carry a pipe inside which the concrete flows, sent by a feed pump (not shown). A segment of flexible pipe (not shown), from which the concrete is delivered to the application place, is normally connected to the last segment. It is understood that the illustration in FIG. 1 is only an example, and must in no way be considered as restricting the field of protection to which the present invention refers.

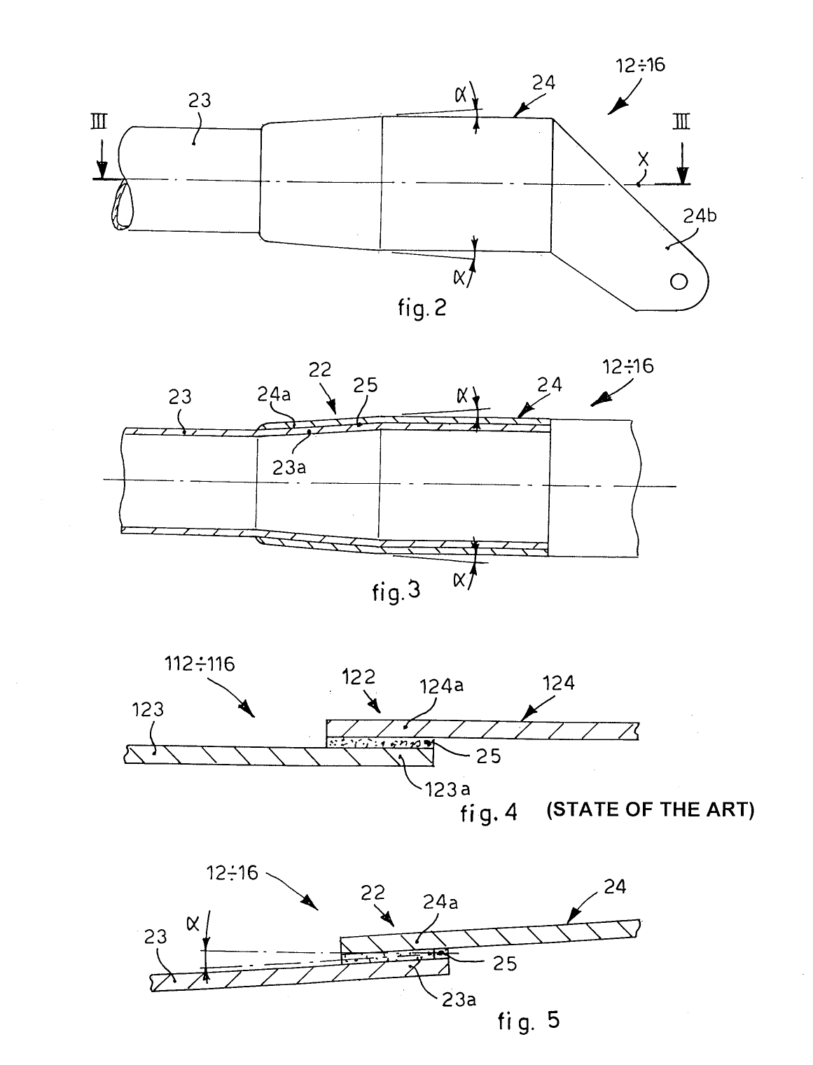

FIG. 2 shows a portion of articulated segment 12-16 comprising a portion of box-like structure 23 a joint element 24. As shown in FIG. 3 and in the schematic drawing in FIG. 5, the box-like structure 23 has an end 23a with a profile inclined by an angle α with respect to the longitudinal axis x of the box-like structure 23. The same inclination is made on an end 24a of the joint element 24. The element 24, at the opposite end, has a connection terminal 24b for articulation to another articulated segment 12-16 of the arm 10. The ends 24a of the joint element 24 cooperating with the respective ends 23a of the box-like structure 23 are glued on the outside of the surface of the box-like structure 23, defining an overlapping area, or conical coupling area, 22, where a layer of glue 25 is interposed. The axial force, the effect of a flexion moment applied to the arm 10 in movement, is locally resolved into two components, a shearing force and a normal force. The modulus of the shearing force, responsible for the sliding of the contact surfaces 23a and 24a one on top of the other, is less than the modulus of the shearing force applied between two ends 123a and 124a with a profile having zero inclination (FIG. 4), all other conditions being the same. The normal component of the axial force is responsible for the separation of the glued ends 23a and 24a but, in the case of inclined profiles glued together, its modulus is negligible because the angle α is sufficiently small. The normal component is zero I the case of ends 123a and 124a having profiles with a zero angle of inclination with respect to the longitudinal axis “x” (FIG. 4). In this last case, the axial force coincides with the shearing force.

It is clear that modifications and/or additions of parts may be made to the arm made of composite material and the method to produce it as described heretofore, without departing from the field and scope of the present invention.

It is also clear that, although the present invention has been described with reference to some specific examples, a person of skill in the art shall certainly be able to achieve many other equivalent forms of arm made of composite material and the method to produce it, having the characteristics as set forth in the claims and hence all coming within the field of protection defined thereby.

1. An arm made of composite material, comprising a plurality of articulated segments with a longitudinal main axis (x), pivoted to each other, each of said articulated segments comprising a box-like structure and at least a joint element attached thereto by means of gluing, said box-like structure having an end cooperating with an end of the joint element on the inside of the surface of the joint element, wherein said ends define a substantially conical reciprocally overlapping area and have profiles concordantly inclined by an angle (α) with respect to the longitudinal axis (x).

2. The arm made of composite material as in claim 1, wherein said angle (α) of inclination is comprised between 1 and 5 degrees.

3. The arm made of composite material as in claim 1, wherein said angle (α) of inclination is comprised between 2.5 and 3.5 degrees.

4. A method to make an arm made of composite material comprising a plurality of articulated segments with a longitudinal main axis (x), pivoted to each other, each of said articulated segments comprising a box-like structure and at least a joint element attached thereto by means of gluing, said box-like structure having an end cooperating with an end of the joint element on the inside of the surface of the joint element, the method comprising a step in which said box-like structure and said joint element are made separately and in such a manner that at least one end of each of the two has a profile inclined by an angle (α) with respect to the longitudinal axis (x) and a step in which said ends are concordantly glued, making a substantially conical joint.

5. The method as in claim 4, wherein said angle (α) of inclination is comprised between 1 and 5 degrees.

6. The method as in claim 4, wherein said angle (α) of inclination is comprised between 2.5 and 3.5 degrees.
